(19) United States
(12) Patent Application Publication
(10) Pub. No.: US 2001/0027753 A1
(43) Pub. Date: Oct. 11, 2001

(54) Cat excrement system with mixed carbon bed filter

(76) Inventor: Daniel W. Ball, Houston, TX (US)

Correspondence Address: Wendy K.B. Buskop, Buskop Law Group, P.C., Suite 500, 1717 St. James Place, Houston, TX, 77056, US

(21) Appl. No.: 09/850,501

(22) Filed: May 7, 2001

Related U.S. Application Data
(63) Continuation-in-part of application No. 09/451,871, filed on Dec. 1, 1999.
Application No. 09/451,871 is a continuation-in-part of application No. 08/943,974, filed on Oct. 7, 1997, now Pat. No. 6,014,949.

(51) Int. Cl. A01K 1/03

(52) U.S. Cl. 119/484

(57) ABSTRACT

A cat toilet with mixed carbon bed filter and an air expulsion apparatus to remove noxious odor away and out of the air inside the pet owner's home.

### BACKGROUND OF THE INVENTION

This application is a continuation-in-part of Ser. No. 09/451,871, filed Dec. 15, 1999, due to issue as U.S. Pat. No. 6,227,147 on May 8, 2001, which is a continuation in part of Ser. No. 08/943,974 filed Oct. 7, 1997, issued as U.S. Pat. No. 6,014,949 on Jan. 18, 2000.

This invention relates to air treatment of the surroundings of a house pet, such as a cat or dog.

The present invention relates to a variation of the co-pending patent application, which is a method for transferring preconditioned air from human domicile to doghouse. The average dog house has a floor, roof and four walls. There is an opening in one end for entry. Dog houses are generally positioned in the back yard of the owners home. They are too hot or cold, stuffy and damp, therefore are seldom used. Geographically transplanted animals suffer most. (Such as Alaskan Huskies in Houston, Tx.). It is not always convenient to have your animal in the house. Even letting them in and our can sometimes be dangerous. (We forget!) There are also many diseases and parasites associated with lying on the open ground. A climate controlled, guilt free, safe house on the outside of the home that would always be accessible to the animal would be highly desirable to both pet and owner. The most common reason, (according to the Houston S.P.C.A.), for people abandoning their pets is, “I can't have them in the house and can't stand to see them suffer.”

This variation is a cat toilet. The invention utilizes a similar construction for the removal of cat excrement odors from a cat toilet through a filtration system.

### OBJECTS OF THE INVENTION

It is an object of the present invention to provide a safe and comfortable toilet for cats to use inside a house with a device, which sucks the nasty odors from the cat toilet utilizing a mixed carbon filter system which utilizes a mixture of lime and clay, and also incorporates a cleaning device to help keep a pet healthy and free of particulates and other foreign matter.

### SUMMARY OF THE INVENTION

The cat toilet comprises a box having a bottom, a top/lid and four sides. It has a entrance portal, which is an intake for air as well as to provide an opening/door for the cat to pass in and out through. The cat toilet may have an airflow curtain at the entrance portal to provide privacy for the cat while its using the toilet. Furthermore, the cat toilet has an exhaust system, which comprises a motor/box fan assembly and a filter apparatus, which is connected to the removable top of the box. The filter apparatus is modified to have a mixed carbon bed. As for power, a power cord for providing electricity to the motor/box fan assembly connected to a 12 volt, 24 volt or 110 volt electric outlet can be used. The box fan is mounted at the exhaust at the outer most inside portion of the manifold box. Additionally, the invention may further include a brush covered opening, so that when the pet, such as a cat, passes through the entrance portal of the cat toilet, the cat's coat is brushed, and pariculate matter stays in the cat toilet, and is prevented from further circulating through the air of the house of the pet owner.

### BRIEF DESCRIPTION OF THE DRAWINGS

FIG. 1 is a side view of the filtration system;

FIG. 2 is a different side view of the motor housing showing the filter port;

FIG. 3 is a side view of the filter used in the invention;

FIG. 4 is side view of the filtration system mounted on the cat toilet;

FIG. 5 is a front view of the filtration system mounted on the cat toilet;

FIG. 6 is a top view of the cat toilet showing the filter assembly port;

FIG. 7 is a front view of the cat toilet without the removable top/lid.

### DETAILED DESCRIPTION OF THE PREFERRED EMBODIMENTS

The present invention is a cat toilet with a mixed carbon filter to absorb and to dissipate the odor from the cat's excrement. Generally, the cat toilet comprises a box having a bottom, a top/lid and four sides. It has a portal entrance, which acts as an air intake as well as to provide an opening for the cat to pass in and out through. The cat toilet may have an airflow curtain at the portal entrance to provide privacy for the cat. Furthermore, the cat toilet has an exhaust system, which is a motor/box fan assembly and a filter apparatus, which is connected to the top/lid of the box, and wherein the top/lid of the box is further connected to a cat toilet enclosure, containing a litter box and a most charming curtain, so that the cat can have privacy while using the litter box. The filter apparatus is modified to have a mixed carbon bed.

The invention further includes damping means contained within the filtration system to regulate the amount of airflow from the cat toilet enclosure containing the litter box to the filter and then discharged back (to the air outside of the box) into the air of the interior of the pet owner's house, clean and fresh to the smell.

A fan, typically an electric fan, although a wind up fan could be used, is attached to the top/lid of the box of the cat toilet to cause air to flow through the portal entrance, past the damping means in the filtration system, and then discharged back (to the air outside of the box) into the air of the interior of the pet owner's house, clean and fresh to the smell.

It has been found useful to utilize camming means connected to the damping means and further attached to a microswitch which engages the fan, and wherein the damping means is adjusted to regulate the amount of air flow from inside the cat toilet enclosure to the filter, and then discharged back (to the air outside of the box) into the air of the interior of the pet owner's house, clean and fresh to the smell.

Electrical wires are used as connecting means and are wired so as to run inside the tubing connecting the microswitch and the fan to a power source.

The cat toilet enclosure preferably is designed with four walls, a bottom, a removable top, an entrance portal/door/opening with an air control curtain and a kitty litter tray.

In the most preferred embodiment, the fan is a 12-volt DC current fan having 0.13 amps.

Finally, it is considered that the damping means and fan could be configured so as to force air in only one direction on, rather than being bidirectional.

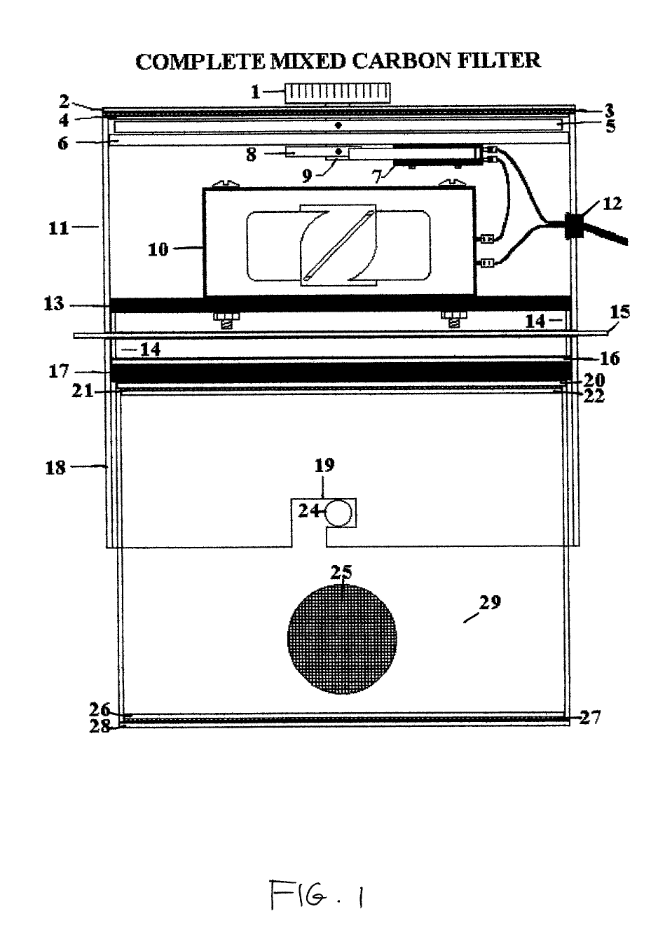

The following detail is now provided in reference to the drawings. As shown in FIG. 1, an on/off cammed damper control 1 is secured to one end of the box 32 of the cat toilet. Exhaust port 2 has a faceplate prefereably made of styrene. A wire mesh screen 3 is disposed over the port.

Exhaust port 4 has a backing disc preferably made of styrene and a damping disc 5 preferably made of styrene. An exhaust port microswitch mounting disc 6 is mounted on the disc, and this mounting disc is also preferably made of styrene.

The microswitch 7 can have a microswitch cam 8, which is preferably made of styrene. An on/off cam 9 with a damper control shaft is installed for operation of the microswitch. A motor assembly 10 is connected to the control switch, which is preferably at least a 0.13 Amp fan/motor assembly. The motor has a motor housing 11, which utilizes a 12 volt, DC power supply cord 12. The motor is mounted on a motor mounting disc 13, which is preferably made of number 80 cross linked rubber. The motor housing is mounted to a filter port splicing ring 14, wherein the ring is preferably an ABS material. The assembly mounting flange disc 15 is used which is preferably made from styrene. The motor housing intake port disc 16 is mounted over the assembly mounting flange disc. The motor housing intake port is preferably formed using a disc of styrene. A donut gasket, preferably of closed cell foam 17 is used to mount the filter port housing 18. The filter port housing has an offset locking notch 19. The filter faceplate disc 20 has an exhaust port. A wire mesh screen 21 is disposed over the filter. A filter backing disc with exhaust port 22 is used with the filter. The filter material 23 is preferably a mixed carbon, zeolite clay and lime mixture. The filter is held in by a filter locking pin 24. The sidewall intake port 25 is also covered by a wire mesh screen 25a. The filter backing disc 26 is used with intake port 26. A second wire mesh screen 27 is used. A filter faceplate disc and intake port 28 is used to hold the filter media housing 29.

The cat toilet room box 32 preferably has an entrance portal 33 which can be covered with brush hairs, a toilet box lid 30 and a filter assembly port 31. An optional air control curtain 34 can be used with this invention.

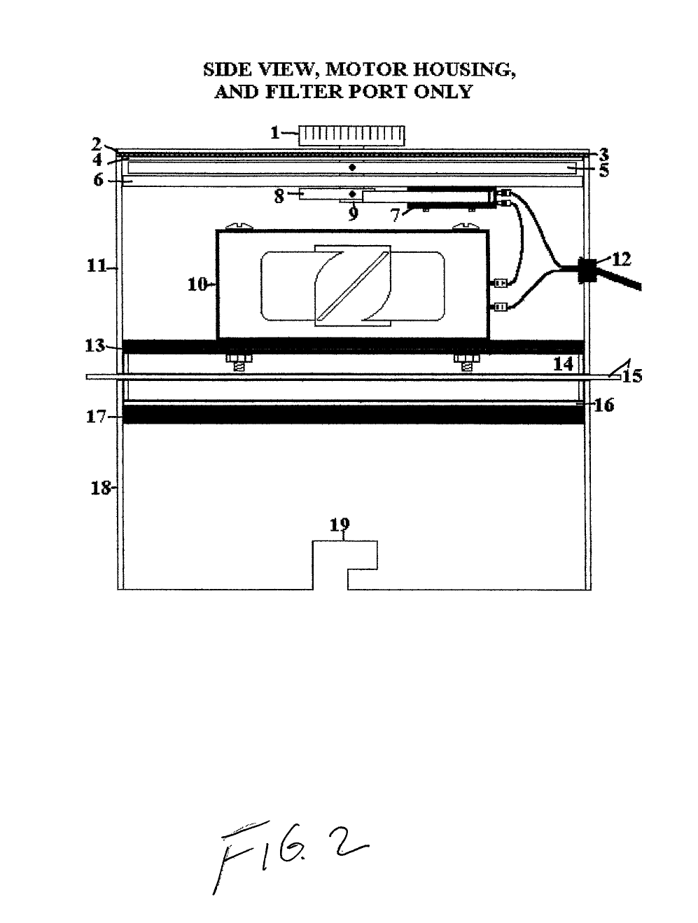

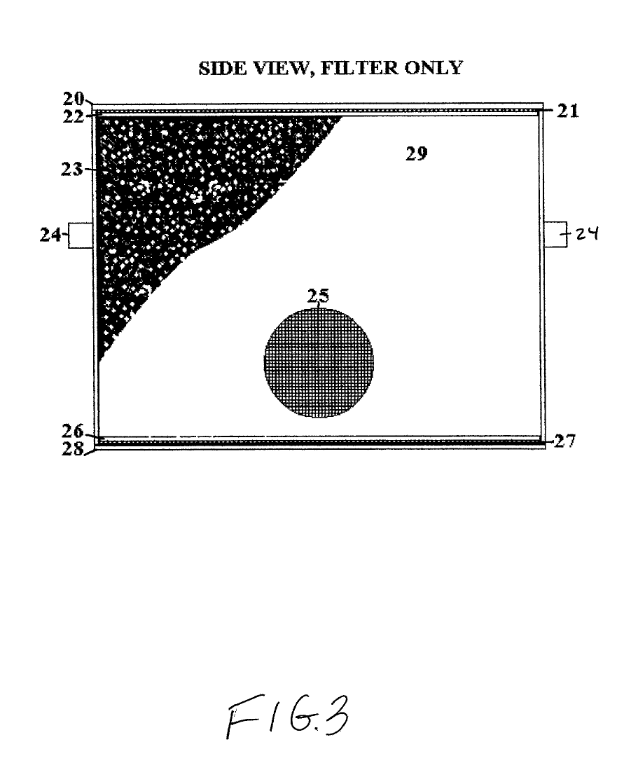

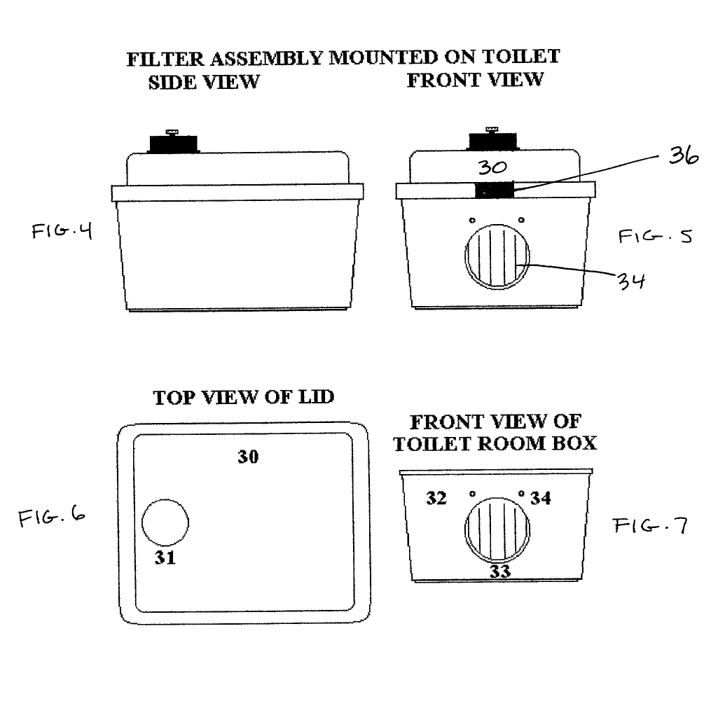

FIG. 2 shows a different side view of the invention with the filter port and motor housing. In this view, an on/of cammed damper control 1 is secured to one end of the box 32 of the cat toilet. Exhaust port 2 has a faceplate prefereably made of styrene. A wire mesh screen 3 is disposed over the port.

Exhaust port 4 has a backing disc preferably made of styrene and a damping disc 5 preferably made of styrene. An exhaust port microswitch mounting disc 6 is mounted on the disc, and this mounting disc is also preferably made of styrene.

The microswitch 7 can have a microswitch cam 8, which is preferably made of styrene. An on/off cam 9 with a damper control shaft is installed for operation of the microswitch. A motor assembly 10 is connected to the control switch, which is preferably at least an 0.13 Amp fan/motor assembly. The motor has a motor housing 11, which utilizes a 12 volt, DC power supply cord 12. The motor is mounted on a motor mounting disc 13, which is preferably made of number 80 cross linked rubber. The motor housing is mounted to a filter port splicing ring 14, wherein the ring is preferably an ABS material. The assembly mounting flange disc 15 is used which is preferably made from styrene. The motor housing intake port disc 16 is mounted over the assembly mounting flange disc. The motor housing intake port is preferably formed using a disc of styrene. A donut gasket, preferably of closed cell foam 17 is used to mount the filter port housing 18. The filter port housing has an offset locking notch 19.

FIG. 3 is a side view of the filter only. It comprises a filter faceplate disc, and exhaust port 20, a wire mesh screen 21, a filter backing disc, and exhaust port 22, a carbon, zeolite, clay and lime mixture 23, a filter locking pin 24, a sidewall intake port 25, and wire mesh screen 25a, a filter backing disc, and intake port 26, a wire mesh screen 27, a filter faceplate disc, and intake port 28, and a filter media housing 29. Air is drawn in through the laminated intake port assembly (laminated intake port assembly comprises filter backing disc, and intake port 26, wire mesh screen 27 and filter faceplate disc, and intake port 28; sheet glue is used between filter backing disc, and intake port 26, and wire mesh screen 27 as well as between wire mesh screen 27, and filter faceplate disc, and intake port 28) which is fixably attached to the filter media housing 29. Air is also drawn through the sidewall intake ports 25, and wire mesh screen 25a, up through the mixed carbon, zeolite, clay and lime 23, and out through the fixably attached, laminated exhaust port assembly (laminated exhaust port assembly comprises filter faceplate disc, and exhaust port 20, wire mesh screen 21 and filter backing disc, and exhaust port 22; sheet glue is used between filter faceplate disc, and exhaust port 20, and wire mesh screen 21 as well as between wire mesh screen 21, and filter backing disc, and exhaust port 22) where it is discharged back into the air of the interior of the pet owner's house, clean and fresh to the smell.

FIG. 5 shows a filter assembly mounted on the toilet from a front view. This figure illustrates the box 30 having a cat entrance portal 33 with an air control curtain 34, a removable top/lid 30, and top locking clamps 36.

In the preferred embodiment, a 110 volt ac/12 volt dc transformer 35 is used to power the system which is high voltage residential ac current which transforms it to low voltage dc current so that the invention is pet safe.

Cat toilet enclosure 32 is a rectangular box big enough to accommodate a cat and kitty litter container, with four walls, a bottom, a removable attached top 30, and air control curtain 35 for a cat to pass in and out through.

In the preferred embodiment, the cat toilet has a removable top 30 for making the pet owner's job of servicing and cleaning the cat toilet easier.

Additionally, top locking clamps 36 are metal clamps fixably attached to the rectangular box enclosure 32, which are bent in a manner so as to clamp the removable top in place. The preferred manner to attach the top 30 to the box 32 is by fitted grooves. The perimeter of the base of the top 30 has an extended piece of plastic that securely fits in a groove at the perimeter of the uppermost part of the box 32.

In the most preferred embodiment, the invention works as follows:

The filtration system contains activated charcoal, zeolite, lime and clay. This filter assembly is removably attached to the toilet box lid at one end. There is an opening at the opposite end of a size to allow a cat to pass through. Inside the large box there is litter tray filled with kitty litter pebbles.

When the on/off, cam, and damper control knob 1, is rotated, the shaft 9 rotates the damper 5 to the open position, and rotates the cam 8 to its flat lobe, the microswitch 7 is attached to the microswitch mounting disc 6, is allowed to open, completing the electrical circuit which is supplied by a 110V ac to 12V dc transformer 35 to a 0.13 amp 12Vdc fan 10, which draws air in through the entrance portal 33, and the air control curtain 34 at the front of the box 32, across the litter tray, into the bottom intake port 28, 27, 26, and the side intake port 25 of the filter, up through the filter body 29 and mixed carbon media 23, out through the filter exhaust port 22, 21, 20, this is where the donut gasket 17 seals the filter assembly to the filter port housing 18 with a filter locking pin 24 twistlocked into the filter port offset locking notch 19, so that no air leaks going into the motor housing intake port 16 and up through the assembly mounting flange disc 15, through the motor housing to filter port splicing ring 14 through the fan/motor mounting disc 13, and into the fan/motor where it is pushed out and into the motor housing 11, where it finally is discharged through the exhaust port assembly 2, 3, and 4, which is on top of the complete assembly, fitted into the filter assembly port 31 at the top and back of the toilet room box lid 30, which may be securely held in place by top locking clamps 36 or which may be securely held in place by fitted grooves, clean and fresh to the smell. There is also a 12Vdc power supply, cord lock 12.

The damper can be closed and the fan/motor shut off when the filter is being serviced to avoid sucking up hair and lint, which will tangle, and foul the fan/motor.

Activated carbon removes the odors from the cat excrement, zeolite encapsulates the ammonia contained in the cat excrement, and the lime and clay help to neutralize the pH of the cat excrement.

The cat toilet box top/lid 30 is removable for servicing and cleaning the litter tray.

There can also be removably attached circular brush around the entrance portal for the removal of loose hair each time the cat goes in or out.

Having the litter tray enclosed in the toilet box, also helps prevent the excrement coated litter pebbles from being scattered throughout the pet owner's room/house.

The invention has been described in detail with particular reference to certain preferred embodiments thereof, but it will be understood that variations and modifications can be effected within the spirit and scope of the invention.

What is claimed is:

1. A cat excrement system comprising:
(a) a box consisting of a removable top, a bottom, a first side, a second side, a third side and a fourth side;
(b) an entrance portal disposed in said first side;
(c) said top further having an opening, and a filter disposed on said top connected to said opening;
(d) a motor/box fan assembly connected to said top of said box;
(e) mixed carbon bed disposed in said filter further comprising a member of the group consisting of: charcoal, lime, clay and zeolite and combinations thereof;
(f) a power cord for providing electricity to said motor/box fan assembly;
(g) and wherein said second wall has a port in said wall with a wire mesh covering and connecting means connecting said port to said filter.

2. The system of claim 1, wherein said entrance portal further comprises a curtain disposed over said entrance portal.

3. The system of claim 1, wherein said entrance portal has a brush disposed on the periphery of said entrance portal for facilitating in the removal of cat hair.

4. The system of claim 1, further comprising damping means to regulate airflow from said box to said filter.

5. The system of claim 1, wherein said fan is selected from the group: an electric fan and a wind up fan.

6. The system of claim 4, further comprising a microswitch connected to said damping means to engage said fan and to regulate airflow from the box to the filter and to the outside of said box.

7. The system of claim 4, wherein said damping means creates bidirectional air flow.

8. The system of claim 4, wherein said damping means creates unidirectional airflow.
